(19) United States
(12) Patent Application Publication
(10) Pub. No.: US 2006/0173947 A1
(43) Pub. Date: Aug. 3, 2006

(54) Method and structure for a hybrid full-packed storage format as a single rectangular format data structure

(75) Inventors: Fred Gehrung Gustavson, Briarcliff Manor, NY (US); John A. Gunnels, Brewster, NY (US)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: International Business Machines Corporation, Armonk, NY (US)

(21) Appl. No.: 11/045,354

(22) Filed: Jan. 31, 2005

(51) Int. Cl. G06F 7/52

(52) U.S. Cl. 708/607

(57) ABSTRACT

A method (and structure) of linear algebra processing, includes processing a (real or complex) matrix data having elements originally stored in one of a triangular format and a symmetric matrix format in a subroutine designed to process matrix data in a full format. The processing uses a hybrid full packed data structure, which provides a rectangular space characteristic of the full format. The rectangular space is defined by a leading dimension (LD). Inside of the rectangular space are stored a plurality of entities that include all elements of the matrix data originally stored in the triangular or symmetric format.

### CROSS-REFERENCE TO RELATED APPLICATIONS

By addressing a similar problem, albeit with a novel different solution, the present Application is related to U.S. patent application Ser. No. 10/671,933, filed on Sep. 29, 2003, to Gustavson et al., entitled “METHOD AND STRUCTURE FOR PRODUCING HIGH PERFORMANCE LINEAR ALGEBRA ROUTINES USING A HYBRID FULL-PACKED STORAGE FORMAT,” having IBM Docket YOR920030168US1.

### U.S. GOVERNMENT RIGHTS IN THE INVENTION

This invention was made with Government support under Contract No. Blue Gene/L B517552 awarded by the Department of Energy. The Government has certain rights in this invention.

### BACKGROUND OF THE INVENTION

1. Field of the Invention

The present invention relates generally to techniques for improving performance for linear algebra routines, with special significance to optimizing the matrix multiplication process, which lies at the base of many linear solvers. More specifically, a hybrid full packed data structure allows a subroutine based on a rectangular standard row/column major format to be used for triangular and symmetric matrices, thereby providing a three-to-five times improvement in speed and/or a reduction in storage by a factor of two.

2. Description of the Related Art

Scientific computing relies heavily on linear algebra. In fact, the whole field of engineering and scientific computing takes advantage of linear algebra for computations. Linear algebra routines are also used in games and graphics rendering.

Typically, these linear algebra routines reside in a math library of a computer system that utilizes one or more linear algebra routines as a part of its processing. Linear algebra is also heavily used in analytic methods that include applications such as supply chain management, as well as numeric data mining and economic methods and models.

The reason that linear algebra is so ubiquitous is that most engineering/scientific problems comprise non-linear scenarios which are combined by modeling as an aggregation of linearized sections, each respectively described by linear equations. Therefore, a linear network is formed that can be described in matrix format. It is noted here that the terms “array” and “matrix” are used interchangeably in the discussion of the present invention.

In general, a matrix representation, A, can be “simplified” by making a plurality of coordinate transformations so that the solution then becomes trivial to obtain in the final coordinates. Common coordinate transformations include transformation into the identity matrix or into the LU (lower/upper) factors format. A lower triangular matrix is L, and an upper triangular matrix is U. Matrix A becomes equal to the product of L by U (i.e., LU).

The process of coordinate transformation wherein two coordinate systems are combined into a single coordinate system involves matrix multiplication. Hence, the present invention focuses particularly on techniques that will particularly enhance matrix multiplication, but is not so limited. Typically, these linear algebra subroutines are stored in a math library of a computer tool that utilizes one or more linear algebra routines as a part of its processing.

A number of methods are have been used to improve performance of new or existing computer architectures for linear algebra routines.

However, because linear algebra permeates so many applications, a need continues to exist to optimize performance of matrix processing, including the need for efficiency in storing matrix data.

As with the above-identified co-pending Application, a problem addressed herein is the storage format for array data. Conventionally, there are two primary storage formats for array data: the full format in which the data is stored in a rectangular space, and the triangular packed format in which the array data has been converted and stored in triangular space.

The problem with full format is that nearly half of the space is wasted when triangular matrix data is stored in the full format memory space. The problem with the triangular packed format is that the subroutines for performing operations on triangular packed format data are typically much slower than for those performing similar operations on the data in full format.

It would be ideal to be able to avoid at least some of the wasted storage space for triangular full format data. It would be even better if the speed of execution of triangular packed format data could be improved.

### SUMMARY OF THE INVENTION

In view of the foregoing exemplary problems, drawbacks, and disadvantages of the conventional systems, it is, therefore, an exemplary feature of the present invention to provide a technique that improves performance for linear algebra routines.

It is another exemplary feature of the present invention to provide a method and structure to yield a solution to provide higher-performance linear algebra routines for traditionally-slow subroutines that process matrices stored in a triangular packed format.

It is another exemplary feature of the present invention to improve factorization routines which are key procedures of linear algebra matrix processing.

In a first exemplary aspect of the present invention, described herein is a computerized method of linear algebra processing, including processing matrix data having elements originally stored in one of a triangular format and a symmetric matrix format in a subroutine designed to process matrix data in a full format. The processing uses a hybrid full packed data structure which provides a rectangular space characteristic of the full format. The rectangular space is defined by a leading dimension (LD), and inside the rectangular space are stored a plurality of entities that include all elements of the matrix data originally stored in the triangular or symmetric format.

In a second exemplary aspect of the present invention, described herein is an apparatus for linear algebra processing including a processor for processing a matrix data in the manner described above.

In a third exemplary aspect of the present invention, described herein is a signal-bearing medium tangibly embodying a program of machine-readable instructions executable by a digital processing apparatus to perform the above-described method of processing matrix data.

The present invention provides an efficient method to save memory space for storing matrix data that is in the conventional symmetric/triangular packed format. Moreover, the present invention is not confined to symmetric/triangular data, but can also be used for arrays in standard full storage format, wherein the triangular data in the full storage format data is converted directly into the hybrid full packed format described herein, thereby saving space relative to conventional full storage with even a slight improvement in speed of processing of the subroutines.

The present invention also provides a method to increase speed and performance for linear algebra routines using the traditionally-slow subroutines that process matrices stored in the conventional triangular packed format. Because the array data structure of the present invention is a single entity, it provides a benefit over the somewhat similar data structure of the above-identified co-pending Application in which two data structure entities are used. This benefit results because the single array of data is completely accessible using the standard programming technique to locate any element in a rectangular array in a single expression.

Therefore, the present invention takes advantage of more readily available and more easily optimizable routines with minimal impact to programmers, thereby providing programming ease. It also readily adapts to existing software modules structured on the architecture and accessibility of standard rectangular arrays of data. This feature is particularly useful for a library development team, since they can concentrate on development of the full format modules and migrate out of any current packed modules, since HFP is easily implemented by calls to full format modules.

Although the present invention is presented, simply for purpose of discussion, primarily oriented to array data in the triangular format, it is equally applicable to symmetric format data. Moreover, as earlier mentioned, the present invention applies to full format data that holds data of a triangular matrix, by converting into the hybrid full-packed format of the present invention, thereby reducing the storage requirement for such full format data by nearly a factor of two.

Finally, it will be noted later how the present invention has particular appeal for Symmetric MultiProcessor (SMP) codes.

### BRIEF DESCRIPTION OF THE DRAWINGS

The foregoing and other exemplary features, aspects and advantages will be better understood from the following detailed description of exemplary embodiments of the invention with reference to the drawings, in which:

FIG. 1 illustrates the full (rectangular) matrix format compared to the triangular (packed) matrix format;

FIG. 2 illustrates how storing a triangular matrix in memory in full format provides a poor utilization of memory space;

FIG. 3 illustrates pictorially, for comparison with the present invention, the hybrid packed full data structure 300 discussed in the above-identified co-pending Application and the conversion process 301 from triangular matrix data 302 into the rectangular-shaped hybrid packed full format 300 as taught therein;

FIG. 4A illustrates pictorially the process 400 for obtaining the hybrid packed full data structure B of the present invention and the conversion process from lower triangular matrix data a into the rectangular-shaped hybrid packed full format B as taught by the present invention;

FIG. 4B shows the corresponding process 410 for an upper triangular matrix;

FIG. 5 is a flowchart 500 showing the general concept of how the present invention could be used to speed up matrix processing in an existing matrix subroutine package, by eliminating the need to process subroutines in the triangular-packed format or reduce the storage of full format by a factor of two; and

FIG. 6 provides an exemplary flowchart of a Simple Related Partition Algorithm (SRPA) for a matrix factorization subroutrine;

FIG. 7 shows concept of using free space 700 can be used to increase flexibility and minimize storage requirements;

FIG. 8 illustrates an exemplary hardware/information handling system 800 for incorporating the present invention therein; and

FIG. 9 illustrates the aspect of the present invention in which a computer storage medium 900 contains a set of instructions to implement the method of the present invention.

### DETAILED DESCRIPTION OF AN EXEMPLARY EMBODIMENT OF THE INVENTION

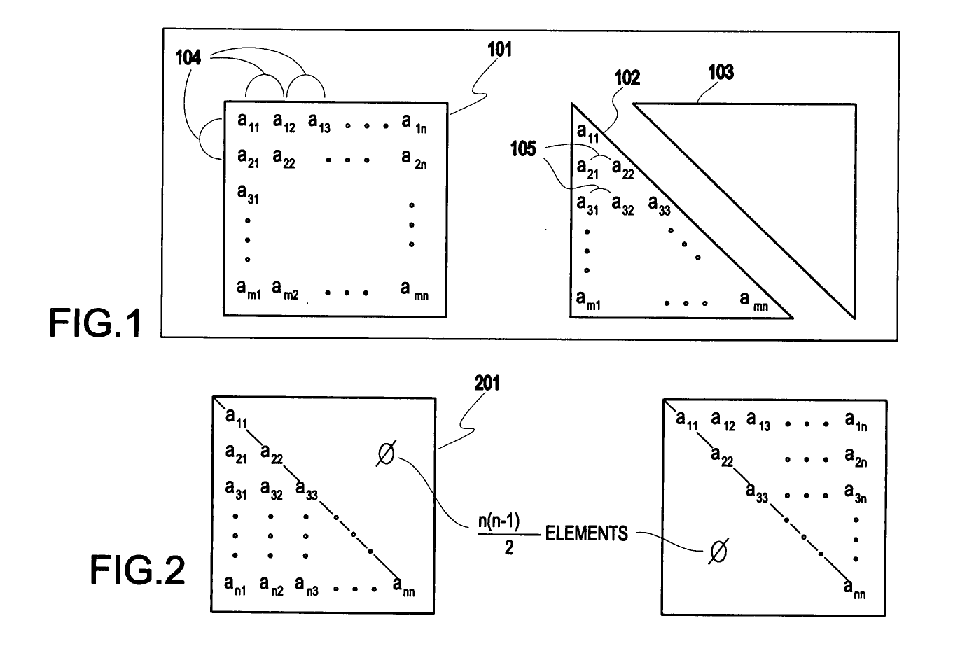

Referring now to the drawings, and more particularly to FIGS. 1-9, an exemplary embodiment of the present invention will now be discussed. Generally, the present invention provides a method to improve speed in linear algorithm processing by noting that linear algebra subroutines that process matrices stored in a rectangular format are three to five times faster than subroutines that process matrices stored in a packed (triangular) format.

The present invention is an extension of the above-identified co-pending Application in that it provides another embodiment of the basic concept of converting matrix array data from a triangular format into a rectangular format that can be readily executed by higher speed linear algebra subroutines oriented to the rectangular format.

Therefore, the above-identified co-pending Application is incorporated herein by reference.

The above co-pending Application provided a hybrid full-packed (HFP) data structure wherein a triangular matrix is converted into two rectangular data structures that could then be processed in linear algebra subroutines oriented to rectangular matrix data.

The present invention extends this basic concept by using a different method wherein the triangular matrix data is converted into a single rectangular data structure, rather than the two rectangular data structures of the HFP format that can then be concatenated into a single rectangular data structure while actually being addressed as two separate entities. As will be better understood shortly, the present invention eliminates having two different LDAs (leading dimensions) for the converted format, since the single data structure of the present invention retains an LDA that is closely related to the LDA of the original array.

Before proceeding with the details of the present invention and how it differs from its related HFP format, and in order to provide a common understanding, a brief discussion of linear algebra processing subroutines follows, as then followed by a brief description of the HFP format of the above co-pending Application.

As previously mentioned, a number of methods have been used to improve performance of computer architectures for linear algebra processing. However, the input data structures of matrices have not changed for conventional programming languages and standardized libraries. That is, two data structures are used for symmetric and/or triangular matrices, including “packed” and “full”.

The “packed” format uses half the storage, but performs, on average, three to five times slower. “Full” format uses twice the storage of packed, but performs three to five times faster than packed and has been observed to perform as high as 20 times faster, especially for large problems where performance is particularly important.

FIG. 1 shows the standard full format 101 familiar to most computer programmers, since Fortran and C operate on arrays as rectangular entities. In contrast, triangular and symmetric arrays 102, 103 store matrix data in a format resembling a triangle, either a lower triangular packed matrix 102 or an upper triangular packed matrix 103.

As shown in FIG. 2, if triangular array 102 is stored in standard full format 201, almost half of the memory positions are “wasted” (e.g., unused). Since full formats 201 are the only formats supported by Fortran and C, they have traditionally been used by most users of dense linear algebra software. The wasted memory space when triangular matrices are stored in memory is a first exemplary problem addressed by the present invention, but there is also addressed other problems including a problem of speed explained below.

Triangular and symmetric matrices T, S are special cases of a full square matrix A (e.g., having order N, where A has n rows and n columns). Triangular and symmetric matrices can be represented in full format. Assuming an example where N=4, the 4×4 matrix A will have 16 elements.

$$T = \begin{matrix}{t}_{11} & 0 & 0 & 0 \\ {t}_{21} & {t}_{22} & 0 & 0 \\ {t}_{31} & {t}_{32} & {t}_{33} & 0 \\ {t}_{41} & {t}_{42} & {t}_{43} & {t}_{44}\end{matrix}$$

$$S = \begin{matrix}{s}_{11} & {s}_{21} & {s}_{31} & {s}_{41} \\ {s}_{21} & {s}_{22} & {s}_{32} & {s}_{42} \\ {s}_{31} & {s}_{32} & {s}_{33} & {s}_{43} \\ {s}_{41} & {s}_{42} & {s}_{43} & {s}_{44}\end{matrix}$$

Because S above is symmetric, it has six redundant elements (e.g., s₂₁, s₃₁, s₄₁, s₃₂, s₄₂, s₄₃), and because T has zeroes above the diagonal, it also has six elements of no interest. Still, storage must be allocated for these six elements. In general, the example above having N=4 shows that N(N−1)/2 elements of triangular and symmetric matrices contain not needed (e.g., 0's or redundant) information.

The following exemplary description of the present invention refers to a current linear algebra computing standard called LAPACK (Linear Algebra PACKage) and various subroutines contained therein. Information on LAPACK is readily available on the Internet. When LAPACK is executed, the Basic Linear Algebra Subprograms (BLAS), unique for each computer architecture and typically provided by the computer vendor, are invoked. LAPACK includes a number of factorization algorithms, some of which will be mentioned shortly.

However, it is noted that the present invention is more generic. That is, the concept presented in the present invention is not limited to LAPACK, as one of skill in the art would readily recognize after having taken the present application as a whole. The present invention is intended to cover the broader concepts discussed herein and contend that the specific environment involving LAPACK is intended for purpose of illustration rather than limitation.

As an example, the floating point operations done on Dense Linear Algebra Factorization Algorithms (DLAFAs) consist almost entirely of matrix multiply subroutine calls such as Double-precision Generalized Matrix Multiply (DGEMM). At the core of level 3 Basic Linear Algebra Subprograms (BLAS) are “L1 kernel” routines which are constructed to operate at near the peak rate of the machine when all data operands are streamed through or reside in an L1 cache.

The current state-of-the-art for DLAFAs is based on using level 3 BLAS on the two matrix data formats, “full format” and “packed format”. Because these data formats are not the data formats used by the level 3 BLAS routines, excessive data copying is necessary, resulting in a performance loss.

The terminology “level x BLAS”, where x=1, 2, or 3, refers to the number of “do” or “for” loops involved. Thus, level 1 BLAS involves a single “do” loop and level 1 BLAS subroutines typically have an order of n operations, where n is the size of the “do” loop. Level 2 BLAS involve two “do” loops and typically have an order n² operations, and level 3 BLAS involve three “do” loops and have an order n³ operations.

The most heavily used type of level 3 L1 DGEMM kernel is Double-precision A Transpose multiplied by B (DATB), that is, C=C−AˆT*B, where A, B, and C are generic matrices or submatrices, and the symbology AˆT means the transpose of matrix A. It is noted that DATB is usually the only such kernel employed by today's state of the art codes, although it is only one of six possible kernels, as was described in commonly-owned application Ser. No. 10/671,935, having Docket No. YOR920030330US1, filed on Sep. 29, 2003, the contents of which are incorporated herein by reference.

More specific to the present invention, the triangular (packed) format 102, 103 shown in FIG. 1 has a stride LD 105 that varies in the vertical dimension. “Stride” is the unit of data separating two consecutive matrix elements (e.g., in row or column, depending upon the storage indexing format) retrieved from memory.

Because of this varying stride, matrix subroutines in LAPACK for the packed format exist only in level 2 BLAS, which is significantly slower than level 3 BLAS matrix subroutines for the full format. As seen in FIG. 1, a full format matrix 101 has a constant stride LD 104 between elements in a row, whereas the triangular format varies.

Hybrid Full-Packed (HFP) Data Structures and Algorithms

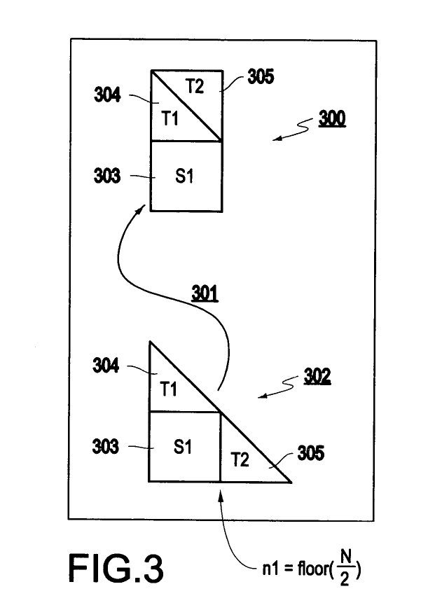

FIG. 3 exemplarily shows the matrix data format 300, the hybrid full-packed format, of the above-identified co-pending Application. The problem addressed in both this co-pending Application and the present invention is that triangular and symmetric arrays 102, 103 stored in standard full format 201 “waste” half of the memory positions. Full formats 101 are the only formats supported by Fortran and C, so they have traditionally been used by most users of dense linear algebra software. These formats allow the use of algorithms that exploit the level 3 BLAS and, therefore, allow such software to attain very high performance.

On the other hand, although the same arrays stored in packed format 102, 103 fully utilize storage by not wasting memory cells, inferior performance and speed is evinced, since there are no level 3 packed BLAS.

The most widely accepted/utilized library for this area is the LAPACK standard, which supplies algorithms for both of the formats just described. An explanation of “conventional storage” and “packed storage” can be found at pages 107-109 of LAPACK User's Guide, 2nd Edition, which is readily available via the Internet. Some of the concepts of the two storage formats are already demonstrated pictorially in FIG. 1.

The above-identified co-pending Application addressed these problems of storage space and speed by combining features of both formats into a new hybrid format, referred to hereinafter as the “Hybrid Full-Packed (HFP) format”, to obtain high performance using level 3 BLAS. Linear algebra matrices stored in this Hybrid Full-packed (HFP) format are compatible with level 3 BLAS routines. That is, they are plug-compatible with routines that conform to the level 3 BLAS standard. That invention also took advantage of LAPACK (and the BLAS) allowing “UPLO” parameters, which indicate that the matrix under consideration is upper triangular or lower triangular.

FIG. 3 shows pictorially the Hybrid Full-packed (HFP) format 300 of the above-identified co-pending Application and the conversion 301 of a triangular (packed) matrix 302 into the HFP data structure. It should be apparent the HFP data structure resembles a rectangular format that is associated with the full format 101 shown in FIG. 1. Hence, since the HFP data structure 300 places the triangular (packed) format 302 into a format that is identical to the full format, it is referred to as the Hybrid Full-packed format.

It should be obvious from FIG. 3 that the conversion from triangular into HFP includes a determination of a square portion S1 303 and two remaining triangular portions T1 304 and T2 305 and a fitting-together of this data to form the rectangular format 300. It should also be obvious that the HFP format 300 could also easily be converted into the triangular format 305 by simply reversing the fitting-together process 301.

Before providing details for the HFP conversion process of the present invention, it should be obvious that the HFP format provides a savings in storing triangular matrix data. The advantage for speed comes from recognizing that the HFP data structure is fully compatible with matrix subroutines in LAPACK written in the faster full (rectangular) format.

The present invention provides another method to achieve a rectangular structure similar to the HFP format concept shown in FIG. 3 in that it likewise provides a conversion of triangular matrix data into a rectangular format compatible with LAPACK. However, the present invention differs in several aspects.

First, the co-pending Application described Symmetric and Triangular arrays as two distinct items. That is, the square section S1 (e.g., item 303 in FIG. 3) comprises a first entity that is indexed in the standard manner, meaning that any element (i, j) is located relative to the beginning of the array data by the expression: Location (i,j)=(0,0)+(i+LDA*j). The second entity comprises the composite T1/T2 array sections 304,305, separately addressed to locate the elements therein. The program has to keep track of elements in these two different array entities.

In contrast, the present invention reduces this data structure to be a single rectangular array, which is both a standard Fortran and C two-dimensional array, thereby allowing a single address mechanism for the entire data structure.

Moreover, by using a single rectangular data structure that retains an LDA closely related to the LDA of the original triangular matrix, the present invention also avoids having the different LDAs of the two separate items discussed in the co-pending Application. The transformation of the present invention can be done substantially in-place, so that the only additional storage is that of the size of the smaller triangle section, an area of size n²/8 words or n²/2 bits. This extra storage applies only to the packed storage case only, since, for full storage, no extra storage is needed.

Moreover, since the transpose of a rectangular array is also a representation of the original array, there are available two additional representations of a given symmetric and/or triangular array. This advantage allows a user to choose which of A or A′ will give the better performance.

The Hybrid Full-Packed (HFP) Data Structure of the Present Invention

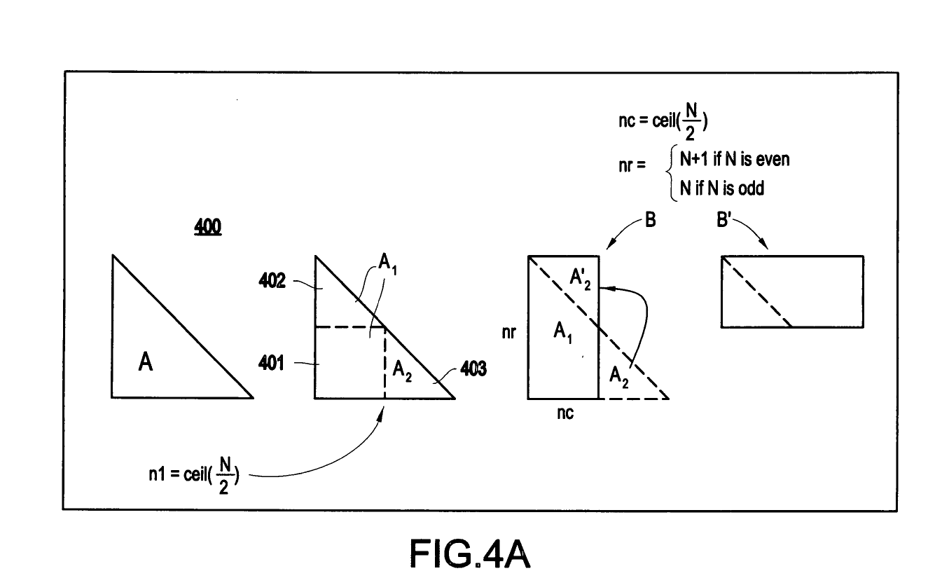

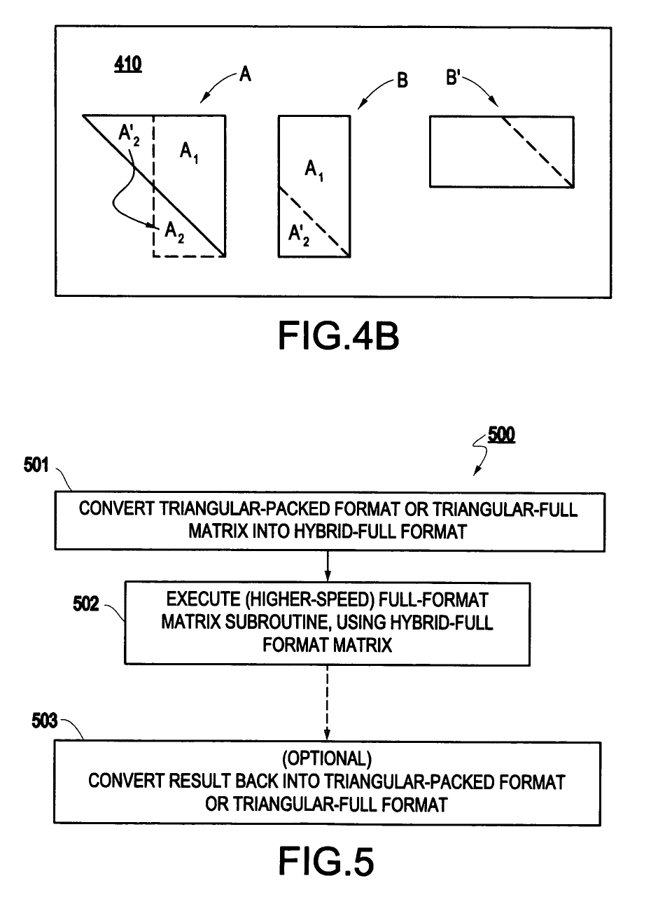

FIG. 4A shows visually the method 400 of the present invention, using the lower triangular case for triangular array A, and FIG. 4B shows the corresponding concept for the upper triangular array A. The technique is similar if array A is a symmetric array, rather than triangular.

A standard 2-D array in Fortran is governed by its leading dimension (e.g., LDA). In the method of the present invention, letting n1=ceil(N/2), the array section 403 of columns n1+1 to N represents a lower triangular matrix A2 of size n2=floor(n/2), with section 402 being the upper triangular corresponding to T1 in FIG. 3. The first n1 columns of A, referred to in FIG. 4A as “A1”, is a trapezoid having two sections 401,402.

As shown in the third figure in FIG. 4, one exemplary method of the present invention is to transpose A2 to form A2′ and then concatenate A2′ together with A1 to form a rectangle of size nr by n1, which is referred to in FIG. 4A as array “B”. Let LDB≧nr. Then, B is a single Fortran array fully describing lower triangular matrix A. Furthermore, the transpose B′ of matrix B shown in the fourth figure, with LDBT≧n1, also fully describes A.

The current LAPACK software is easily modified to work on one or both of the arrays B or B′. The case when A is upper triangular is similar, as shown in FIG. 4B.

In comparing FIGS. 3 and 4A, it should be apparent that the method of the present invention uses a different division for the initial division for the lower triangular section A2 (e.g., ceil (N/2) versus floor (N/2)) and uses the transpose A2′.

Although FIGS. 4A and 4B use different symbols A, A1, A2, and A2′ for purpose of showing the basic difference from the method shown in FIG. 3, the following discussion also uses the symbols S, T1, and T2, analogous with similar constructs in FIG. 3. It will be apparent from the context that the symbols apply to the method shown in FIG. 4 rather than FIG. 3.

The remainder of this discussion provides more details of this summary provided by FIG. 4 and provides a demonstration of modifying any existing LAPACK L3 routine to accommodate this new rectangular full packed format.

Conceptually, two equal or nearly equal isosceles triangles make a square or when they are concatenated along their diagonals.

As more concrete examples, it is assumed that N is given. Examples are given below where N is odd (e.g., N=9) and N is even (e.g., N=8). For convenience, in these examples, the triangular portion T2 to be transposed and relocated is shown in bold type.

Covering the odd and even cases for both UPLO=‘U’ and ‘L’ is general. However, because of symmetry, there can be different ways to define this format. There are two rectangular arrays, LHFP and UHFP, for uplo=‘L’ and ‘U’.

An example is given below. In general, there are two possible cases: N being even, and N being odd. All HPF subarrays in this example are assumed to be in standard column-major (Fortran) format, but this assumption is not necessary.

First Case, N=9 (Odd Number):

| | |
|---|---|
| Upper Triangular- | Lower Triangular- |
| Packed (UP) | Packed (LP) |

| | |
|---|---|
| 00 01 02 03 04 05 06 07 08 | 00 |
| 11 12 13 14 15 16 17 18 | 10 11 |
| 22 23 24 25 26 27 28 | 20 21 22 |
| 33 34 35 36 37 38 | 30 31 32 33 |
| 44 45 46 47 48 | 40 41 42 43 44 |
| 55 56 57 58 | 50 51 52 53 54 55 |
| 66 67 68 | 60 61 62 63 64 65 66 |
| 77 78 | 70 71 72 73 74 75 76 77 |
| 88 | 80 81 82 83 84 85 86 87 88 |

Both UHFP and LHFP formats shown below consist of single full arrays. The UHFP array A holds the upper trapezoid of the last (N+1)/2 columns of UP (i.e., columns 4:8). The transpose of UP (0:3,0:3) is stored there. The LHFP array A holds the lower trapezoid of the first (N+1)/2 columns of LP (i.e., columns 0:4).

At the top of this trapezoid, there is an upper triangle of size (N−1)/2. The transpose of LP (i.e., 5:8,5:8) is stored there.

| UHFP A | LHFP A |
|---|---|
| 04 05 06 07 08 | 00 55 65 75 85 |
| 14 15 16 17 18 | 10 11 66 76 86 |
| 24 25 26 27 28 | 20 21 22 77 87 |
| 34 35 36 37 38 | 30 31 32 33 88 |
| 44 45 46 47 48 | 40 41 42 43 44 |
| 00 55 56 57 58 | 50 51 52 53 54 |
| 01 11 66 67 68 | 60 61 62 63 64 |
| 02 12 22 77 78 | 70 71 72 73 74 |
| 03 13 23 33 88 | 80 81 82 83 84 |

For uplo=‘U’, the starting positions of T1, T2, and S are (n1+1,0), (n1,0), and (0,0). Here n1=N/2. The order of T1 is n1, of T2 is n1+1, and S has size n1 by n1+1.

For uplo=‘L’, the starting positions of T1, T2, and S are (0,0), (0,1), and (n1,0). Here n1=(N+1)/2. The order of T1 is n1+1, of T2 is n1 and S has size n1 by n1+1.

Both UHFP A and LHFP A matrices have size N by (N+1)/2, with LDA≧N.

Since the transpose of a matrix provides equivalent information, the following two transposed matrices provide equivalent information of the original matrix data.

| (UHFP A)^{T} | (LHFP A)^{T} |
|---|---|
| 04 14 24 34 44 00 01 02 03 | 00 10 20 30 40 50 60 70 80 |
| 05 15 25 35 45 55 11 12 13 | 55 11 21 31 41 51 61 71 81 |
| 06 16 26 36 46 56 66 22 23 | 65 66 22 32 42 52 62 72 82 |
| 07 17 27 37 47 57 67 77 33 | 75 76 77 33 43 53 63 73 83 |
| 08 18 28 38 48 58 68 78 88 | 85 86 87 88 44 54 64 74 84 |

Second Case, N=8 (Even Number):

| | |
|---|---|
| UP | LP |

| | |
|---|---|
| 00 01 02 03 04 05 06 07 | 00 |
| 11 12 13 14 15 16 17 | 10 11 |
| 22 23 24 25 26 27 | 20 21 22 |
| 33 34 35 36 37 | 30 31 32 33 |
| 44 45 46 47 | 40 41 42 43 44 |
| 55 56 57 | 50 51 52 53 54 55 |
| 66 67 | 60 61 62 63 64 65 66 |
| 77 | 70 71 72 73 74 75 76 77 |

Again, both UHFP and LHFP formats shown below consist of a single full array. The UHFP array A holds the upper trapezoid of the last N/2 columns of UP (i.e., columns 4:7). At the bottom of this trapezoid, there is a lower triangle of size N/2. The transpose of the first N/2 columns of UP (i.e., 0:3,0:3) is stored there.

The LHFP array A holds the lower trapezoid of the first N/2 columns of LP (i.e., columns 0:3). At the top of this trapezoid, there is stored an upper triangle of size N/2. The transpose of the last N/2 columns of LP (i.e., 4:7,4:7) is stored there.

| UHFP A | LHFP A |
|---|---|
| 04 05 06 07 | 44 54 64 74 |
| 14 15 16 17 | 00 55 65 75 |
| 24 25 26 27 | 10 11 66 76 |
| 34 35 36 37 | 20 21 22 77 |
| 44 45 46 47 | 30 31 32 33 |
| 00 55 56 57 | 40 41 42 43 |
| 01 11 66 67 | 50 51 52 53 |
| 02 12 22 77 | 60 61 62 63 |
| 03 13 23 33 | 70 71 72 73 |

The order of T1 and T2 is n1 and S is a square of order n1. For uplo=‘U’, the starting positions of T1, T2, and S are (n1+1,0), (n1,0), and (0,0). For uplo=‘L’, the starting positions of T1, T2, and S are (1,0), (0,0), and (n1+1,0). The transposed results are:

| (UHFP A)^{T} | (LHFP A)^{T} |
|---|---|
| 04 14 24 34 44 00 01 02 03 | 44 00 10 20 30 40 50 60 70 |
| 05 15 25 35 45 55 11 12 13 | 54 55 11 21 31 41 51 61 71 |
| 06 16 26 36 46 56 66 22 23 | 64 65 66 22 32 42 52 62 72 |
| 07 17 27 37 47 57 67 77 33 | 74 75 76 77 33 43 53 63 73 |

As a measure of performance, if any LAPACK level 3 routine that uses the standard, traditional packed storage scheme is taken, this routine implements a level 3 block-based algorithm by using packed level 2 BLAS and level 1 BLAS. On average, performance is a factor of three to five or more slower than the LAPACK full format version.

In contrast, the present invention proposes that, instead, a Simple Related Partition Algorithm (SRPA) using block size, in succession, NB=n1, and then NB=n2, is written. When the new SRPA routine on the new HFP data structure is applied, a performance gain factor of three to five or more can be achieved, and improved speeds up to 20 have been observed on larger arrays.

There are approximately 120 such routines in LAPACK. An exemplary SRPA example in coding format is given below for the LAPACK routine, DPPTRF (Double-precision, Packed Positive-definite TRiangular Factorization), i.e., the packed Cholesky factorization.

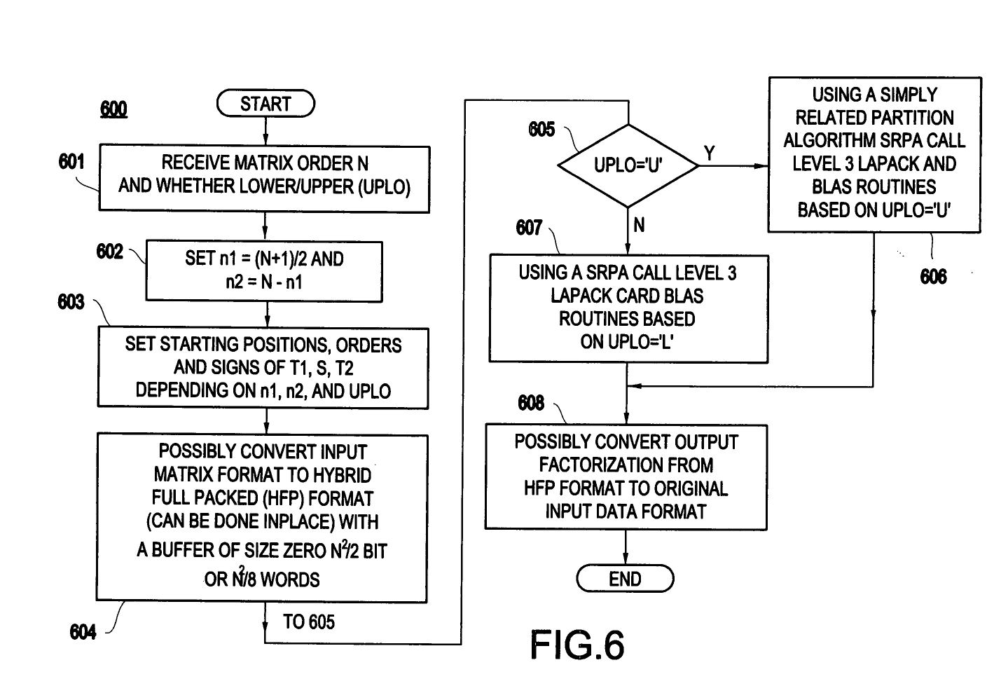

This example using DPPTRF is only for purpose of demonstration, since it should be obvious, after taking the present application as a whole, that the approach using an SRPA, as presented in generalized format in FIGS. 5 and 6, is a generalized concept for these LAPACK routines and can even be easily extended to linear algebra processing outside the conventional LAPACK standard. Two format conversion routines may be required if the data needs to be transformed back-and-forth between packed and hybrid format. It should be obvious that other existing subroutines can be likewise implemented using coding similar to that shown below, as modified to make appropriate subroutine calls.

The SRPA typically includes four subroutine calls to existing level 3 BLAS-based LAPACK codes. Experience with the LAPACK algorithms makes it clear that this example is general for LAPACK algorithms. Further, the technique can be applied to other LAPACK-like algorithms.

FIG. 5 shows the generic process 500 of using the method of the present invention for linear algebra processing. In step 501, the array data is converted from triangular format into rectangular format so that, in step 502, the more efficient full-format subroutines can be executed. Although not typically necessary, in step 503, the result could optionally be converted back into triangular format, if desired. It is noted that the data transformation of the triangular format into HFP format in step 501 can be done in-place.

It can be shown that, for a lower packed triangular matrix having submatrices of sizes S=ns=n1*n2 elements, T1 having n1t=n1(n1+1)/2 elements, and T2 having n2t=n2(n2+1)/2 elements, a buffer of size t2=n2(n2+1)/2≦n/2(n/2+1)/2≈n²/8 would permit an in-place transformation into the HFP data structure.

FIG. 6 shows in flowchart format 600 the following exemplary coding for an SRPA for the DPPTRF matrix factorization subroutine.

In step 601 of FIG. 6, the SRPA receives information on packed matrix AP as to size n and whether the matrix is in lower triangular format or lower triangular format. In step 602, n1, the ceiling (N/2) is calculated by using integer division, and n2 is calculated. In step 603, pointers are set up for the square section S1 and triangular sections T1 and T2.

In step 604, the packed format data is possibly converted into HFP format. This conversion subroutine would be straight forward in view of the mapping above for T1, T2 and S1.

In step 605, it is determined whether the matrix is upper or lower triangular. Based on the determination in step 605, the level 3 BLAS subroutine calls or existing LAPACK routine calls will be made using either upper triangular parameters in step 606 or lower triangular parameters in step 607. It is noted that the routines or subroutines to support the HFP format would be closely related to existing modules so that no new software is needed. Finally, in step 608, the result of the level 3 BLAS Cholesky factorization subroutines are converted back into standard packed format.

Thus, concerning the exemplary coding below, any packed LAPACK L3 routine can be taken. It has a full L3 block algorithm. A simple related partition algorithm SRPA with partition sizes depending on T1, T2, and S can be written and the new SRPA applied on the new HPF data structure.

An example for DPPTRF is given below. The SRPA consists of four subroutine calls to existing L3 codes. Hopefully, it is clear that this example is general. Below the arrays “UHFP A” and “LHFP A” are called just “AH”. AH has size nr by nc and represents an order N symmetric/triangular matrix stored in rectangular full array AH. If N is odd, nc=(N+1)/2 and nr=N, and nr=N+1, if N is even. However, for uplo=‘L’, and ‘U’ and N even and odd, the placement and sizes of T1, T2, and S in AH are different, as demonstrated in the earlier discussion.

### An Exemplary Coding for an SRPA for the DPPTRF Matrix Factorization Subroutine

if (uplo.eq. ‘L’) then

n1 = (n+1)/2 ! n1 is ceil (n/2)
n2 = n-n1 ! n2 is floor(n/2)
j1 = 0 ! --> T1(i1,j1) in AH
js =0 ! --> S(is,js)
i2 = 0 ! --> T2(i2,j2) in AH
if (mod(n,2).eq.0) then

i1=1 ! -->T1(1,0) in AH
j2=0 ! --> T2(0,0) in AH
is=n1+1 ! --> S(n1+1,0) in AH

else ! n is odd

i1=0 ! --> T1(0,0) in AH
j2=1 ! --> T2(0,1) in AH
is=n1 ! --> S(n1,0) in AH

endif

! the routine dpthf converts packed format in AP to HFP format in AH

call dpthf(uplo,N,AP,AH(i1,j1), AH(i2,j2), AH(is,js), lda)

! step 1

call dpotrf(‘L’, n1, AH(i1,j1),lda,info)
if(info.gt.0) return

! step 2

call dtrsm(‘R’,‘L’,‘T’,‘N’,n2,n1,one,AH(i1,j1),lda,AH(is,js),lda)

! step 3

call dsyrk(‘U’,‘N’,n2,n1,-one,AH(is,js), lda,one,AH(i2,j2),lda)

! step 4

call dpotrf(‘U’,n2,AH(i2,j2),lda,info)
if(info.gt.0) info=info + n1

! the routine dhftp converts HF format in AH to packed format in AP

call dhftp(uplo,N,AP,AH(i1,j1),AH(i2,j2),AH(is,js),lda)

else !uplo = ‘U’

n1=n/2 ! n1 is floor(n/2)
n2=n-n1 ! n2 is ceiling(n/2)
is=0
js=0
i1= n1+1
j1=0
i2=n1
j2=0

! the routine dpthf converts packed format in AP to HFP format in AH

call dpthf(uplo,N,AP,AH(i1,j1),AH(i2,j2),AH(is,js),lda)

! step 1

call dpotrf(‘L’,n1,AH(i1,j1),lda,info)
if(info.gt.0) return

! step 2

call dtrsm(‘L’,‘L’,‘N’,‘N’,n1,n2,one,AH(i1,j1),lda,AH(is,js),lda)

! step 3

call dsyrk(‘U’,‘T’,n2,n1,-one,AH(is,js),lda,one,AH(i2,j2),lda)

! step 4

call dpotrf(‘U’,n2,AH(i2,j2),lda,info)
if(info.gt.0)info=info+n1

! the routine dhftp converts HF format in AH to packed format in AP

call dhftp(uplo,N,AP,AH(i1,j1),AH(i2,j2),AH(is,js),lda)
endif

This method is quite general. It offers the possibility to replace all LAPACK packed L2 codes and all LAPACK full L3 codes with new simple L3 codes based on existing LAPACK L3 full format codes. These new simple L3 codes are like the example code given above.

The appeal is especially strong for Symmetric MultiProcessor (SMP) codes, as many L3 BLAS are enabled for SMP implementations. Note that DPTHF and DHFTP offer efficient SMP implementations. Should this HFP format become common, it might be possible to offer any user the ability to only use full format L2 BLAS. The user will not use the current packed L2 BLAS as HFP L2 BLAS are easily implemented by calls to full format L2 BLAS. These new codes will be efficient, as no calls to DPTHF or DHFTP are needed as the data format is already HPF.

As a programming note, it is noted that a user could also input data that is already in HFP format. In that case, the above calls to DPTHF (packed to hybrid format transformation) and DHFTP (hybrid to packed format transformation) are not needed. When the original matrix is in full format, subroutiness DFTHF and DHFTF would be used.

A user provided with routines DPTHF and DHFTP would allow the user to readily perform conversions between (i.e., to and from) standard packed and HFP formats. A user provided with routines DFTHF and DHFTF would allow the user to readily perform conversions between (i.e., to and from) standard full and and HFP formats.

Thus, this present invention affords any library development team the opportunity to replace all of its packed level 2 codes with new simple level 3 codes based on existing LAPACK level 3 full format codes. It also affords any library development team the opportunity to replace all of its full level 3 codes with new simple level 3 codes based on existing LAPACK level 3 full format codes.

Again, the appeal is especially strong for Symmetric MultiProcessor (SMP) codes, since level 3 BLAS, as well as several of the LEQs (Linear EQuations), algorithms usually have good SMP implementations. It is noted that DPTHF and DHFTP offer efficient SMP implementations and that DFTHF and DHFTF offer efficient SMP implementations.

Finally, a library development team need only further develop their full format level 2 BLAS and slowly migrate out the current packed level 2 BLAS, as HFP level 2 BLAS are easily implemented by calls to full format level 2 BLAS. These new codes (packed level 2 BLAS using HFP format input) will be efficient since no calls to DPTHF or DHFTP are needed as then the data format is already HFP.

The DPTHF and DHFTP subroutines offer efficient SMP implementations. Finally, full format L2 BLAS can be developed to replace current packed L2 BLAS, as HFP L2 BLAS are easily implemented by calls to full format L2 BLAS. These new codes will be efficient as no calls to DPTHF or DHFTP are needed as the data format is already HPF.

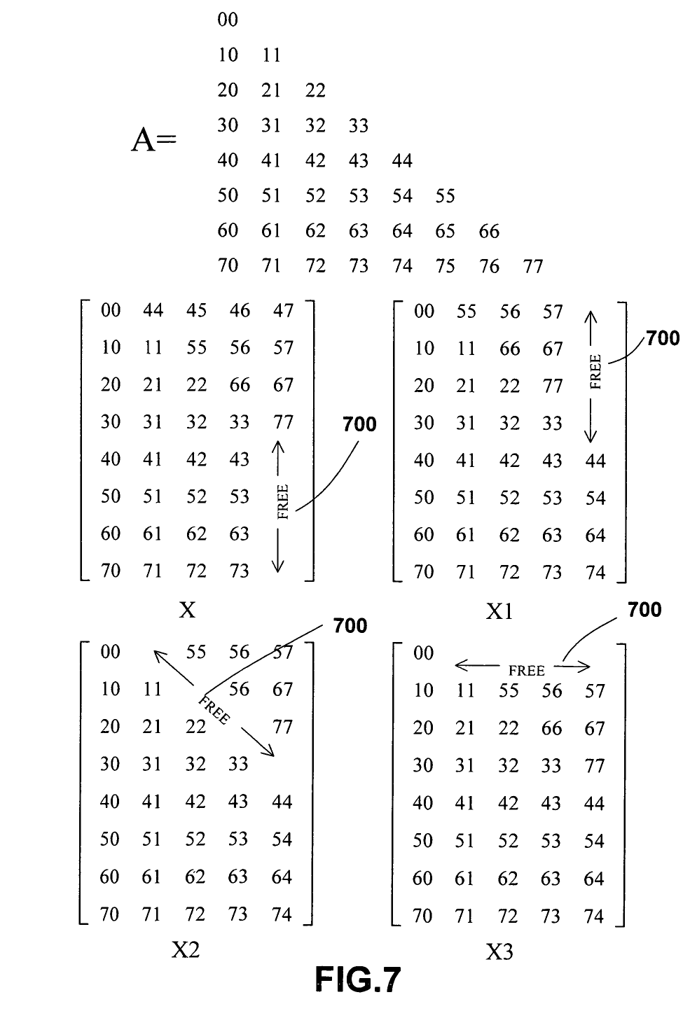

As another technical aspect of the present invention, FIG. 7 is used to demonstrate how free space 700 in the array data can be used relative to minimizing storage. This aspect of the present invention addresses the desire to represent a triangular and/or symmetric matrix A in a rectangular full format array that uses minimal storage. However, reaching a true minimum may destroy other properties.

An example happens when N is even so that A has N+1 rows. One can define full array A1 with N rows and N/2+1 columns. A1 has space for N(N/2+1)=N(N+1)/2+N/2 elements, so there is room for N/2 additional elements in A1. But A1 has N rows. It is obtained from A by splitting at column N/2 and gluing T2 to the right of the 00 element of T1, as shown in X, X1, X2, and X3 of FIG. 7, showing N=8. In these four examples X, X1, X2, and X3 of FIG. 7, T1/S and T2 have been placed into A1 in four different ways.

The generalization is to make the split in A at column index j starting at ceil (N/2). Let j increase to N−1. Keep nr=N. The array becomes larger and larger, as does A1=T1/S, which stays pinned at location (0,0). Array T2 order goes from n2 to 0. T2 can be placed anywhere in the upper triangle in which it will fit. Most, if not all, of the properties still hold. But now there is an additional property, that being the location and size of T2, as well as the size of T1/S. The free space 700 provides flexibility that can be important in distributed memory computer systems. The drawback is that additional storage is required.

It should be apparent to one of ordinary skill in the art, after having taking this disclosure as a whole, that there are a number of variations to the exemplary embodiment discussed above.

First, it is noted that the present invention applies to matrices having both real and/or complex data.

Second, although the exemplary embodiment discussed above fitted the triangular portion T2 into the rectangular format by transposing the data, there are other variations. For example, the triangular portion T2 data could be placed using reverse addressing or variants thereof. For example, the case given above for an odd number (e.g., N=9) might have fitted the T2 data using, for example, one of the following variations from that of the transposed version.

| UHFP A | LHFP A |
|---|---|
| 04 05 06 07 08 | 00 88 87 86 85 |
| 14 15 16 17 18 | 10 11 77 76 75 |
| 24 25 26 27 28 | 20 21 22 66 65 |
| 34 35 36 37 38 | 30 31 32 33 55 |
| 44 45 46 47 48 | 40 41 42 43 44 |
| 33 55 56 57 58 | 50 51 52 53 54 |
| 22 23 66 67 68 | 60 61 62 63 64 |
| 11 12 13 77 78 | 70 71 72 73 74 |
| 00 01 02 03 88 | 80 81 82 83 84 |

or even

| | |
|---|---|
| 04 05 06 07 08 | 00 85 86 87 88 |
| 14 15 16 17 18 | 10 11 75 76 77 |
| 24 25 26 27 28 | 20 21 22 65 66 |
| 34 35 36 37 38 | 30 31 32 33 55 |
| 44 45 46 47 48 | 40 41 42 43 44 |
| 33 55 56 57 58 | 50 51 52 53 54 |
| 23 22 66 67 68 | 60 61 62 63 64 |
| 13 12 11 77 78 | 70 71 72 73 74 |
| 03 02 01 00 88 | 80 81 82 83 84 |

In general, it should be recognized that the present invention teaches that matrix data for triangular and/or symmetric matrices can be broken down into a plurality of shapes that can be refitted together to fit into a substantially rectangular shape having a smaller storage requirement and whose elements (i,j) can be addressed as a block using standard Fortran or C language indexing for which element (i,j) is located in memory using the standard expression i+LDA·j, where LDA is the leading dimension of the reconstructed rectangular entity.

Although the exemplary embodiment used the specific example having a single square S and single triangular portion T2 left over once S has been identified, there is no limitation intended that there be a single square or rectangular portion S and only one or two triangular portions T1,T2. There could be any number of subdivisions, as long as these subdivisions can be fitted together into a rectangular space that can be addressed using the standard expression given above.

Thus, in the discussion above, the T1, S, T2 portions are three exemplary pieces of the original triangle of data. One could have several triangles/rectangles, and each could have separate LDA's, as in the above-identified co-pending Application. Each piece is addressable by i+1d*j for some 1d. The sum of all figures must add up to nt=0.5N*(N+1) locations, where nt≦nr*nc≦N².

Moreover, as mentioned above and illustrated in FIG. 7, the reconstructed rectangular entity might intentionally incorporate more space than necessary for minimal storage of the data.

Exemplary Hardware/Software Implementation

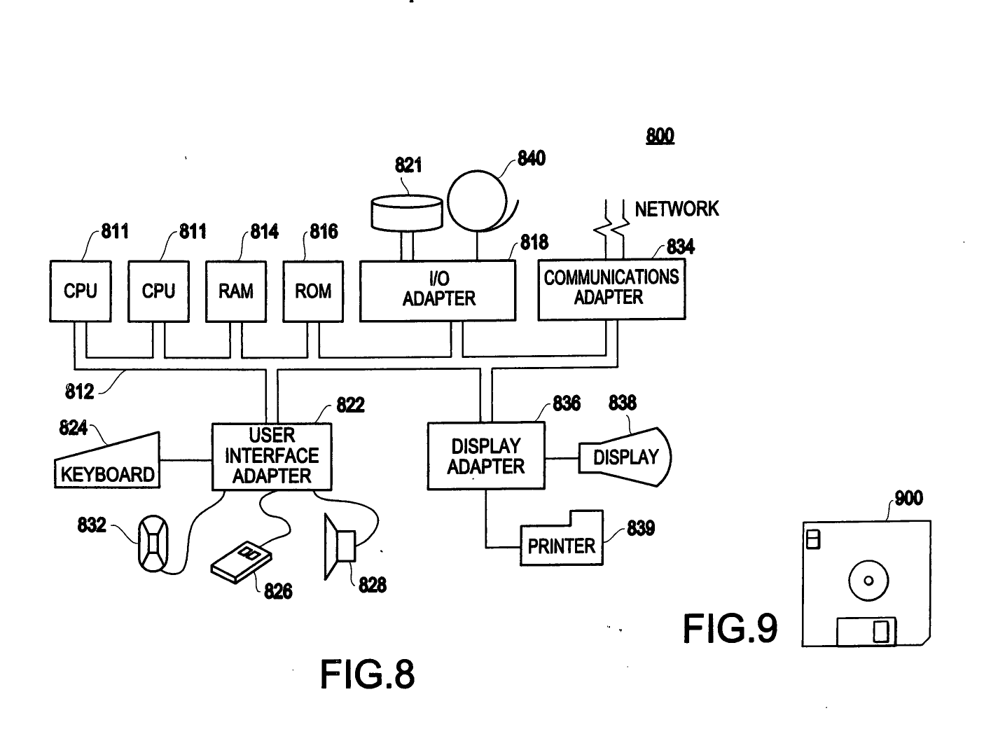

FIG. 8 illustrates a typical hardware configuration of an information handling/computer system 800 usable with the present invention, as described later, and which computer system preferably has at least one processor or central processing unit (CPU) 811. In the exemplary architecture of FIG. 8, the CPUs 811 are interconnected via a system bus 812 to a random access memory (RAM) 814, read-only memory (ROM) 816, input/output (I/O) adapter 818 (for connecting peripheral devices such as disk units 821 and tape drives 840 to the bus 812), user interface adapter 822 (for connecting a keyboard 824, mouse 826, speaker 828, microphone 832, and/or other user interface device to the bus 812), a communication adapter 834 for connecting an information handling system to a data processing network, the Internet, an Intranet, a personal area network (PAN), etc., and a display adapter 836 for connecting the bus 812 to a display device 838 and/or printer 839 (e.g., a digital printer or the like).

In addition to the hardware/software environment described above, a different aspect of the invention includes a computer-implemented method for performing the invention.

Such a method may be implemented, for example, by operating a computer, as embodied by a digital data processing apparatus, to execute a sequence of machine-readable instructions. These instructions may reside in various types of signal-bearing media.

Thus, this aspect of the present invention is directed to a programmed product, comprising signal-bearing media tangibly embodying a program of machine-readable instructions executable by a digital data processor incorporating the CPU 811 and hardware above, to perform the method of the invention.

This signal-bearing media may include, for example, a RAM contained within the CPU 811, as represented by the fast-access storage for example. Alternatively, the instructions may be contained in another signal-bearing media, such as a magnetic data storage diskette 900 (FIG. 9), directly or indirectly accessible by the CPU 811.

Whether contained in the diskette 900, the computer/CPU 811, or elsewhere, the instructions may be stored on a variety of machine-readable data storage media, such as DASD storage (e.g., a conventional “hard drive” or a RAID array), magnetic tape, electronic read-only memory (e.g., ROM, EPROM, or EEPROM), an optical storage device (e.g. CD-ROM, WORM, DVD, digital optical tape, etc.), paper “punch” cards, or other suitable signal-bearing media including transmission media such as digital and analog and communication links and wireless.

The second aspect of the present invention can be embodied in a number of variations, as will be obvious once the present invention is understood. That is, the methods of the present invention could be embodied as a computerized tool stored on diskette 800 that contains a series of matrix subroutines to solve scientific and engineering problems using matrix processing in accordance with the present invention. Alternatively, diskette 800 could contain a series of subroutines that allow an existing tool stored elsewhere (e.g., on a CD-ROM) to be modified to incorporate one or more of the principles of the present invention.

The second aspect of the present invention additionally raises the issue of general implementation of the present invention in a variety of ways.

For example, it should be apparent, after having read the discussion above that the present invention could be implemented by custom designing a computer in accordance with the principles of the present invention. For example, an operating system could be implemented in which linear algebra processing is executed using the principles of the present invention.

In a variation, the present invention could be implemented by modifying standard matrix processing modules, such as described by LAPACK, so as to be based on the principles of the present invention. Along these lines, each manufacturer could customize their BLAS subroutines in accordance with these principles.

It should also be recognized that other variations are possible, such as versions in which a higher level software module interfaces with existing linear algebra processing modules, such as a BLAS or other LAPACK module, to incorporate the principles of the present invention.

Moreover, the principles and methods of the present invention could be embodied as a computerized tool stored on a memory device, such as independent diskette 800, that contains a series of matrix subroutines to solve scientific and engineering problems using matrix processing, as modified by the technique described above. The modified matrix subroutines could be stored in memory as part of a math library, as is well known in the art. Alternatively, the computerized tool might contain a higher level software module to interact with existing linear algebra processing modules.

It should also be obvious to one of skill in the art that the instructions for the technique described herein can be downloaded through a network interface from a remote storage facility.

All of these various embodiments are intended as included in the present invention, since the present invention should be appropriately viewed as a method to enhance the computation of matrix subroutines, as based upon recognizing how linear algebra processing can be more efficient by using the principles of the present invention.

In yet another aspect of the present invention, it should also be apparent to one of skill in the art that the principles of the present invention can be used in yet another environment in which parties indirectly take advantage of the present invention.

For example, it is understood that an end user desiring a solution of a scientific or engineering problem may undertake to directly use a computerized linear algebra processing method that incorporates the method of the present invention. Alternatively, the end user might desire that a second party provide the end user the desired solution to the problem by providing the results of a computerized linear algebra processing method that incorporates the method of the present invention. These results might be provided to the end user by a network transmission or even a hard copy printout of the results.

The present invention is intended to cover all these various methods of using the present invention, including the end user who uses the present invention indirectly by receiving the results of matrix processing done in accordance with the principles of the present invention.

That is, the present invention should appropriately be viewed as the concept that efficiency in the computation of matrix subroutines can be significantly improved for triangular packed matrix subroutines by converting the triangular data into the hybrid full-packed data structure, thereby allowing the processing to be executed using full-format subroutines that inherently have higher performance.

The present invention provides a generalized technique that improves performance for linear algebra routines. The method and structure discussed here, yields higher-performance linear algebra routine processing for traditionally-slow subroutines that process matrices stored in a triangular packed format and can provide three to five fold or more performance improvement over these subroutines.

While the invention has been described in terms of exemplary embodiments, those skilled in the art will recognize that the invention can be practiced with modification within the spirit and scope of the appended claims.

Further, it is noted that, Applicants' intent is to encompass equivalents of all claim elements, even if amended later during prosecution.

Having thus described our invention, what we claim as new and desire to secure by Letters Patent is as follows:

1. A computerized method of linear algebra processing, said method comprising:
processing a matrix data having elements originally stored in one of a triangular format and a symmetric matrix format in a subroutine designed to process matrix data in a full format, said processing using a hybrid full packed data structure, said hybrid full packed data structure providing a rectangular space defined by a leading dimension (LD), inside of which said rectangular space are stored a plurality of entities that include all elements of said matrix data originally stored in said triangular or symmetric format.

2. The method of claim 1, wherein said rectangular space comprises memory elements (i,j) and any memory element (i,j) of said rectangular space is locatable in a memory space, relative to a starting point of said matrix data, by using a standard array location expression (i+LD·j) where LD is a leading dimension of said standard array.

3. The method of claim 1, wherein each entity Aₖ of said plurality of entities respectively has a leading dimension 1dₖ, the respective leading dimensions not necessarily being equal for all said entities.

4. The method of claim 3, wherein said rectangular space includes “don't care” data elements that are used as free space and do not contain any of said elements of said matrix data originally stored in said triangular or symmetric format.

5. The method of claim 1, further comprising:
converting said matrix data from said triangular or symmetric matrix format into said hybrid full packed data structure, said converting comprising:
decomposing said data in said triangular or symmetric format into a plurality of geometrical entities; and
recombining said plurality of entities into said rectangular space of said hybrid full packed data structure.

6. The method of claim 5, wherein said converting is executed in-place in said memory space.

7. The method of claim 5, wherein temporary additional memory space is allocated for said converting.

8. The method claim 1, wherein said hybrid full packed data structure comprises:
a substantially square portion of said matrix data originally stored in said triangular or symmetric format;
a first triangular portion of said matrix data originally stored in said triangular or symmetric format, and
a second triangular portion of said matrix data originally stored in said triangular or symmetric format, as having been transposed,
wherein said substantially square portion, said first triangular portion, and said second triangular portion are fitted together inside said rectangular space.

9. The method of claim 1, wherein said subroutine designed to process matrix data in said full format comprises a LAPACK (Linear Algebra PACKage) software module.

10. The method of claim 9, wherein said subroutine comprises a variant of a full-format routine of a LAPACK level 3 BLAS (Basic Linear Algebra Subroutine).

11. The method of claim 10, wherein said level 3 BLAS comprises an L1 kernel routine, wherein L1 comprises an L1 cache in a computer.

12. The method of claim 5, wherein said converting comprises:
determining a portion of said matrix data stored in said triangular or symmetric matrix format that would comprise a substantially square portion having a dimension approximately one half a dimension of said matrix data.

13. The method of claim 12, further comprising:
transposing a triangular portion of said matrix data and fitting said transposed triangular portion into a location relative to data of said square portion.

14. An apparatus for linear algebra processing, said apparatus comprising:
a processor that processes a matrix data having elements originally stored in one of a triangular format and a symmetric matrix format in a subroutine designed to process matrix data in a full format, said processor using a hybrid full packed data structure, said hybrid full packed data structure providing a rectangular space defined by a leading dimension (LD), inside of which said rectangular space are stored a plurality of entities that include all elements of said matrix data originally stored in said triangular or symmetric format.

15. The apparatus of claim 14, further comprising:
a receiver that receives said matrix data originally in said triangular or symmetric matrix format, said processor further converting said matrix data received in said triangular or symmetric matrix format into said hybrid packed data structure.

16. The apparatus of claim 14, wherein said processor comprises one of a plurality of processors interconnected in parallel.

17. A signal-bearing medium tangibly embodying a program of machine-readable instructions executable by a digital processing apparatus to perform at least one of:
a method of processing a matrix data having elements originally stored in one of a triangular format and a symmetric matrix format in a subroutine designed to process matrix data in a full format, said processing using a hybrid full packed data structure, said hybrid full packed data structure providing a rectangular space characteristic of said full format, said rectangular space defined by a leading dimension (LD), inside of which said rectangular space are stored a plurality of entities that include all elements of said matrix data originally stored in said triangular or symmetric format; and
instructions to convert said matrix data from said triangular or symmetric matrix format into said hybrid packed data structure.

18. The signal-bearing medium of claim 17, wherein said medium comprises one of:
a stand-alone diskette; and
a memory unit in a server on a network.

19. The method of claim 1, wherein said method is used to one of solve and apply a scientific/engineering problem, said method further comprising at least one of:
providing a consultation for solving a scientific/engineering problem using said linear algebra software package;
transmitting a result of said linear algebra software package on at least one of a network, a signal-bearing medium containing machine-readable data representing said result, and a printed version representing said result;
receiving a result of said linear algebra software package on at least one of a network, a signal-bearing medium containing machine-readable data representing said result, and a printed version representing said result; and
developing a standard library software module that processes matrix data using said hybrid full packed data structure.
